(19) United States
(12) Patent Application Publication
(10) Pub. No.: US 2025/0278607 A1
(43) Pub. Date: Sep. 4, 2025

(54) ASSISTIVE GENERATIVE AI-BASED RESPONSES

(71) Applicant: Intuit, Inc., Mountain View, CA (US)

(72) Inventors: Ishani DOSHI, San Diego, CA (US); Anant SAXENA, San Diego, CA (US); Chase ROOSSIN, San Diego, CA (US); Meng CHEN, Mountain View, CA (US); Rohan Karthik ADGALA, San Diego, CA (US); Varadarajan SRIRAM, San Diego, CA (US)

(21) Appl. No.: 18/592,377

(22) Filed: Feb. 29, 2024

(51) Int. Cl. G06N 3/0455

(52) U.S. Cl. CPC G06N 3/0455

(57) ABSTRACT

Certain aspects of the disclosure provide systems and methods for generating generative artificial intelligence (AI) explanations of application outputs responsive to user questions. In an embodiment, a method includes receiving, at an AI orchestrator, a user question regarding an application. The method further includes determining, with the AI orchestrator, to generate a generative AI response to the user question with a generative AI model, generating a prompt for a generative AI model based on the user question and processing the prompt with the generative AI model to generate the generative AI explanation; and providing the generative AI explanation for responding to the user question.

### BACKGROUND

### Field

Aspects of the present disclosure relate to artificial intelligence, and more specifically, to generative AI responses to user queries associated with applications.

### Description of Related Art

Intelligent virtual assistants (IVAs) are software agents that assist users in various tasks. IVAs may be implemented, for example, as chatbots configured to converse with a user in natural (e.g., human-understandable) language. For example, users may converse with an IVA through text or voice messages to obtain support or resolve problems with an application.

Users may interact with an IVA when experiencing problems with an application, for example, to obtain information about how to complete a task. Users may also interact with an IVA with questions concerning features, outputs, or outcomes of the application, for example, requesting an explanation, asking follow-up questions, seeking additional details, etc. IVAs are generally configured to provide a responsive message, however, such messages are often generic in the sense that they do not take into account user-specific information when formulating the response. Further, a responsive message may direct the user to further support resources, such as a frequently asked question webpage or support article associated with the application. Owing to the generic nature of the response from the IVA, users may not be confident in the suggested recourse, or more generally in the application as a whole.

Users may find generic responses from IVAs unhelpful and confusing because, for example, such responses are not responsive to the user's specific question, provide too much information, or provide irrelevant information. This problem is exacerbated when the application relates to a complex domain in which complicated determinations, calculations, and large amounts of data are used to generate application outputs.

Accordingly, there is a need for improved systems and methods for responding to user questions regarding application activity.

### SUMMARY

Certain aspects provide a computer-implemented method, comprising: receiving, at an artificial intelligence (AI) orchestrator a user question regarding an application used by a user; determining, with the AI orchestrator, to generate a generative AI response to the user question with a generative AI model; generating a prompt for the generative AI model based on the user question, comprising: receiving user application session information associated with the user and the application output; providing the user application session information to a knowledge engine; receiving from the domain-specific knowledge engine a knowledge engine explanation; generating the prompt based on the knowledge engine explanation; providing the prompt to the generative AI model; receiving from the generative AI model the generative AI response; and providing the generative AI response for responding to the user question.

Certain aspects provide for a computer-implemented method, comprising: receiving, at an artificial intelligence (AI) orchestrator a user question regarding an application used by a user; determining, with the AI orchestrator, to generate a generative AI response to the user question with a generative AI model, comprising: determining a domain associated with the user question; and determining the user question comprises a request for an explanation of an output of the application; generating a prompt for the generative AI model based on the user question, comprising: receiving user application session information associated with the user and the application; providing the user application session information to a knowledge engine; receiving from the knowledge engine a knowledge engine explanation, wherein the knowledge engine explanation is in XML format; and generating the prompt based on the knowledge engine explanation, comprising parsing the knowledge engine explanation for information elements used in the prompt for the generative AI model; providing the prompt to the generative AI model; receiving from the generative AI model the generative AI response; and providing the generative AI response for responding to the user question, wherein the generative AI response comprises a chat message for sending via a chat service.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example system for generating user-specific generative AI responses associated with an application.

FIG. 2 depicts an example user interface for responding to user questions with generative AI responses associated with an application.

FIG. 3 depicts an example workflow for generating user-specific generative AI explanations and responding to a user.

FIG. 4 depicts an example sequence diagram for generating user-specific generative AI explanations and responding to a user.

FIG. 5 depicts an example method for generating a response to a user comprising a user-specific generative AI explanation of an application output.

FIG. 6 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for responding to user questions with generative artificial intelligence (GenAI) explanations associated with application outputs. In particular, certain embodiments are directed to generating the responsive GenAI explanations based on domain- and user-specific information and providing the responses via a chat interface, such as via a chatbot or IVA.

As above, IVAs may be configured to provide information regarding applications, such as in regard to the applications' output, in response to user questions. Often, such chatbots are provided as part of a support service. For example, a user may reach out to a support service via a chat message to obtain information related to an application. A chatbot may provide a generic or predetermined response, for example, directing a user to a self-help section (e.g., frequently asked questions section, article, etc.) for additional information. Such responses may include irrelevant information, lack relevant information, and/or cause confusion regarding the applicability of such information. For example, a user may ask for more information regarding a particular application output, and be directed to a self-help article. While the self-help article may provide information, a user may confused as to what, if any, of the information contained in the article is relevant to the specification application output encountered by the user.

Application outputs are often determined based on technical and domain-specific knowledge and data, for example, by performing complex calculations using large amounts of data. For example, in a tax return preparation application, tax calculations may be complex and based on many different types of tax data and complicated tax laws, rules, and regulations. User questions regarding such technical and domain-specific application output may be poorly formed, and may consequently cause chatbots to respond incorrectly to user questions. For example, a user may omit or misuse a domain-specific technical term (e.g., “Did my tax refund get filed?” instead of “Did my tax return get filed?”). Owing to this seemingly minor error, a chatbot may not provide accurate and responsive information.

Embodiments described herein provide technical solutions to resolve the aforementioned technical problems. Certain embodiments described herein provide for systems and methods for responding to user questions with GenAI explanations associated with application features, outputs, and/or outcomes based on domain and user specific information. Users may query an application for additional information regarding a feature, output, or outcome, for example, by interfacing with an application, sending a chat message to a chat service, etc. In embodiments, user questions regard an application output and a response comprises an informative explanation of the application output. Such responses are generated with GenAI models to provide personalized and informative responses.

In examples, a response includes user- and domain-specific information utilized by the application to determine the output. For example, an application configured to make credit decisions based on the user's data and interactions with application, as well as credit approval domain knowledge and calculations. A user may ask questions regarding the credit decision, for example, “What is my debt-to-income ratio?” and a response may include description of the user's attributes, such as user income and user debt, and application of such information to domain knowledge to calculate the user's debt-to-income ratio. Thereby, a user receives a personalized response and may verify the information (e.g., user income and user debt) used by the application in making the credit decision. Beneficially, such a response provides a user-specific response. Conventional systems may simply recite a rule for determining debt-to-income ratio, e.g., divide monthly debt payments by gross monthly income, and embodiments described herein provide an improvement over such systems by providing user-specific responses.

Furthermore, responses described herein may be narrowly tailored, for example, based on a user question and/or application outcome, to provide relevant and pertinent information. Returning to the previous credit decision example, other information not relevant to the user question regarding debt-to-income ratio, may not be provided, reducing irrelevant and extraneous information.

Additionally, responses may be provided in a human-understandable manner, and further, in a conversational manner, for example, to be sent to a user via a chat message. Thus, responses provide concise and clear information explanations of application activity. Further, responses may be generated based on targeting non-expert audiences.

Aspects described herein beneficially utilize GenAI models to generate such responses. Generative artificial intelligence generally includes machine learning models configured to generate text, image, and other data outputs based on an input prompt. A prompt is generally an instruction or request, often posed in natural language provided to a machine learning model (e.g., a large language model) in order to cause the machine learning model to perform a particular task and/or generate a specific output. In some cases, prompts are generated through a text and/or voice interface. Prompts may be transformed into numerical representations, such as tokens, so that they may be processed by machine learning models.

Large language models (LLMs) may be trained to perform a variety of NLP tasks, such as generating and classifying text, answering prompts in a conversational manner, and translating text from one language to another. NLP makes it possible for software to “understand” typical human speech or written content as an input into an LLM-based system and to respond to it by, in some cases, generating human-understandable responses through natural language generation (NLG).

A popular LLM, which has gained much recent attention is “ChatGPT,” produced by OpenAI®. Generative pre-trained transformer (GPT) models, such as ChatGPT, are a specific type of LLM based on a transformer architecture (e.g., architecture that uses an encoder-decoder structure and does not rely on recurrence and/or convolutions to generate an output), pre-trained in a generative and unsupervised manner (e.g., it learns form data without being given explicit instructions on what to learn). GPT models analyze prompts and predict the best possible response based on their understanding of the language. In particular, GPT models rely on the knowledge they gain after their many parameters are trained on relevant datasets.

One technical problem with generative models, such as LLMs, involves ensuring the generated response is based on accurate user- and domain-specific information. For example, LLMs may hallucinate by providing a factually incorrect or nonsensical generative output. Embodiments described herein may reduce hallucination by providing instructions as part of a prompt for the generative model. Such instructions may improve performance by guiding the model to a best and accurate response. For example, instructions may include exemplary input and output examples, such as to guide the model to desired output. Instructions may additionally or alternatively include task specification instructions, for example, instructions to generate a text summary or answer in a conversational manner. Thus, model performance may be beneficially improved.

Embodiments described herein may further utilize user and domain-specific information in composing the prompt for the generative model. By providing such information in the prompt, the generative model may utilize the user and domain-specific information in generating the output. Furthermore, hallucination may be reduced because the model is instructed to use the information to generate accurate responses. Domain-specific information may include domain knowledge, such as domain rules and their application to the user's outcome. Prompting the generative model with such domain-specific information may reduce incorrect and/or nonsensical generative output.

Certain embodiments described herein utilize a knowledge engine configured to capture domain knowledge, such as through domain-specific models, rules, and data. An application may utilize the knowledge engine to generate an outcome related to the user question and further provide such domain knowledge to the generative model as domain-specific information to generate the response. Thus, beneficially, domain knowledge, calculations, and explanations (e.g., reasoning/or application of domain models and/or rules) utilized by the application may also be utilized by the generative model in generating the response. For example, in a tax return preparation application, tax knowledge, including tax rules and data may be provided to the generative model as part of the prompt to ensure generation of a technically accurate response. Furthermore, the response is beneficially generated based on application activity, e.g., the domain knowledge, calculations, and explanations to generate the application output.

Another technical problem with generative models is that they are generally limited in the number of tokens they can consider in a prompt, such as up to 10,000 tokens. The generative model may be limited by the token limit due to the memory and processing power. Generally, large prompts (e.g., in terms of token count) may significantly increase resource usage, including power and processing time, which may further increase latency of an application relying on the output of the generative model. As described herein, a prompt may utilize domain-specific information, including domain knowledge, calculations, and explanations, in addition to instructions, and/or examples. In some examples, the number of tokens associated with the domain knowledge and calculations may far exceed the token limit for input to a GenAI model.

Aspects described herein overcome this technical problem by providing for systems and methods to reduce the prompt size, while maintaining the critical information for generating an adequate explanation. In certain embodiments, aspects include a parser model configured to parse the domain knowledge and calculations associated with a user and an application output to generate a prompt usable by the generative model. The parser model may be trained to generate a compressed prompt, for example, a prompt with a reduced number of tokens compared to the number of tokens associated with the domain knowledge and calculations. Thus, the prompt the generative model is configured to process may have a reduced number of tokens.

Additionally, the response may be provided to a use via a chat service, for example, as a chat message (e.g., voice or text message), integrated with or associated with the application. A user may receive a query response on the application's user interface, avoiding the conventional requirement to navigate to a separate chat application. Furthermore, in certain embodiments, a user question may be generated based on user interaction with the user interface, for example, by selection of a user interface element of the application interface. Thereby, a user may query for additional information without needing to input (e.g., via a text or voice input) a separate message, while still obtaining information related to the user's specific application output.

In certain embodiments, a user question may be submitted via a chat service, such as through a text or voice message. A user may receive a personalized response based on the user's specific application output because the generative models described herein utilize the user and domain-specific information in generating the response. Thus, users may receive a personalized explanation directly associated with the application and/or application support service.

### Example System for Generating Generative AI Explanations Associated With Application Output

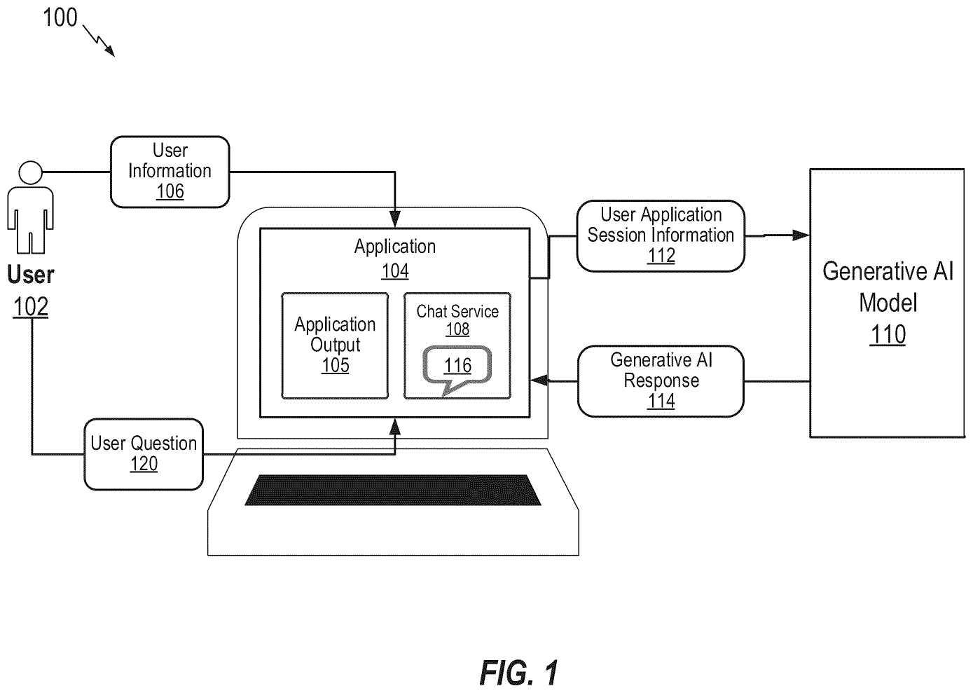

FIG. 1 depicts an example system 100 for responding to user questions with a user-specific GenAI explanation associated with output from an application. In some cases, system 100 may be used to generate GenAI responses for domain-specific applications (e.g., tax preparation) that utilize domain knowledge (e.g., tax laws, rules, and regulations) to perform domain-specific tasks (e.g., computation of an income tax return for a user). Example domain-specific applications include tax preparation, customer support, medical diagnosis, media and content, and others. System 100 may be used to generate GenAI responses for generalized applications that perform functions relevant to many different domains, such as a word processing application, messaging application, and others.

In FIG. 1, user 102 interacts with an application 104 by providing user information 106 through a user interface associated with application 104. In some cases, application 104 may be a domain-specific application. Based on user information 106, application 104 may determine an application output 105. As an example, in a tax preparation application, user 102 may provide user income information and user demographic information as inputs for determining tax calculations (e.g., application output 105). As another example, in a medical diagnosis application, user 102 may provide user medical information, user symptoms, and user demographic information, as inputs for determining medical diagnostics (e.g., application output 105).

In this example, application 104 includes a chat service 108. Chat service 108 is configured to provide a response 116 to a user question 120 comprising a request for an explanation associated with application output 105. In some embodiments, user question 120 may comprise a request for explanation of determinations and calculations made by application 104 in generating application output 105.

In one example, user 102 may submit a user question by selecting a specific user interface element, such as a “help” or “information” element and thereafter entering the question in an appropriate interface element. In another example, user 102 may submit a question via chat service 108.

Response 116 comprises a user-specific explanation relating to application output 105 and responsive to user question 120. In some cases, response 116 includes additional information, such as domain-specific details, rules, knowledge, and/or user information 106 used by application 104 to generate application output 105. Further, response 116 may be a conversational response generated for a non-expert audience.

Returning to the tax preparation example, user question 120 may be “What tax credits did I receive?” and response 116 may include information regarding tax credits on a tax return (e.g., application output 105) of user 102, including tax rules and credits, based on user information 106. Response 116 may be geared towards a non-expert audience, for example, a regular tax payer, not a tax preparer.

Returning to the medical diagnostic application example, a user question 120 may be “What is the treatment?” and response 116 may include information regarding treatment of a medical diagnosis (e.g., application output 105) of user 102, including medical history, disease pathology, etc., based on user information 106. Further, response 116 may be generated in a manner for a patient, not a physician.

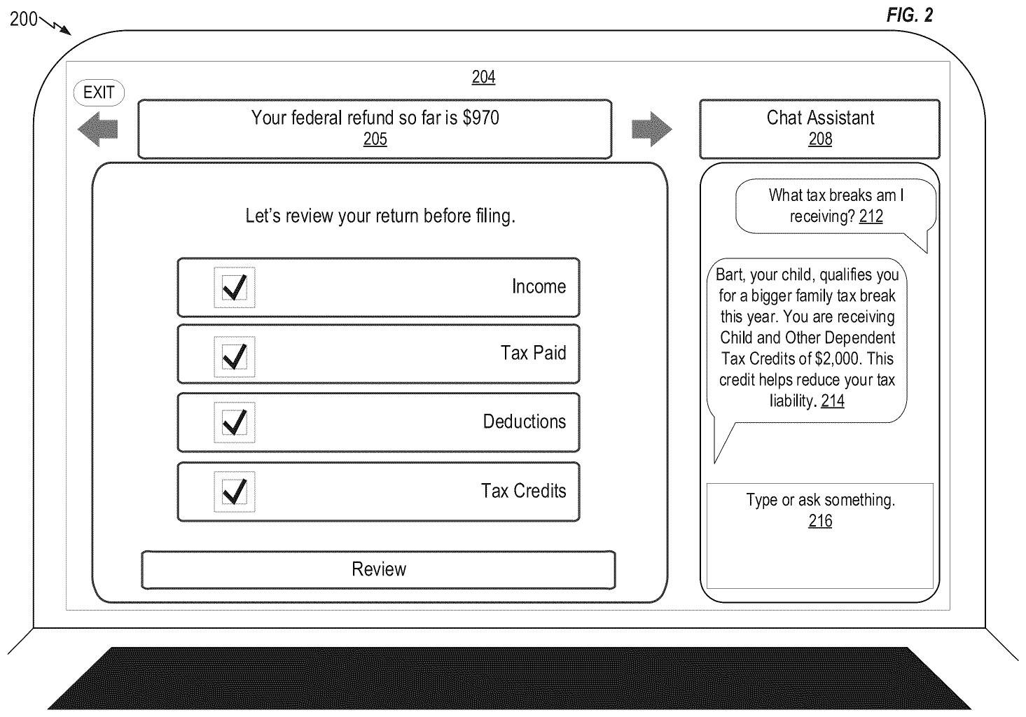

Application 104 may be a web-based application or a native application, in either case capable of running on a variety of computing devices, including personal computers, tablet computers, smart devices, and others. In the depicted example, application 104 includes a user interface configured to enable user 102 to interact with application 104 through a user computing device, for example, to input user information 106. FIG. 2 depicts an example user interface of application 104.

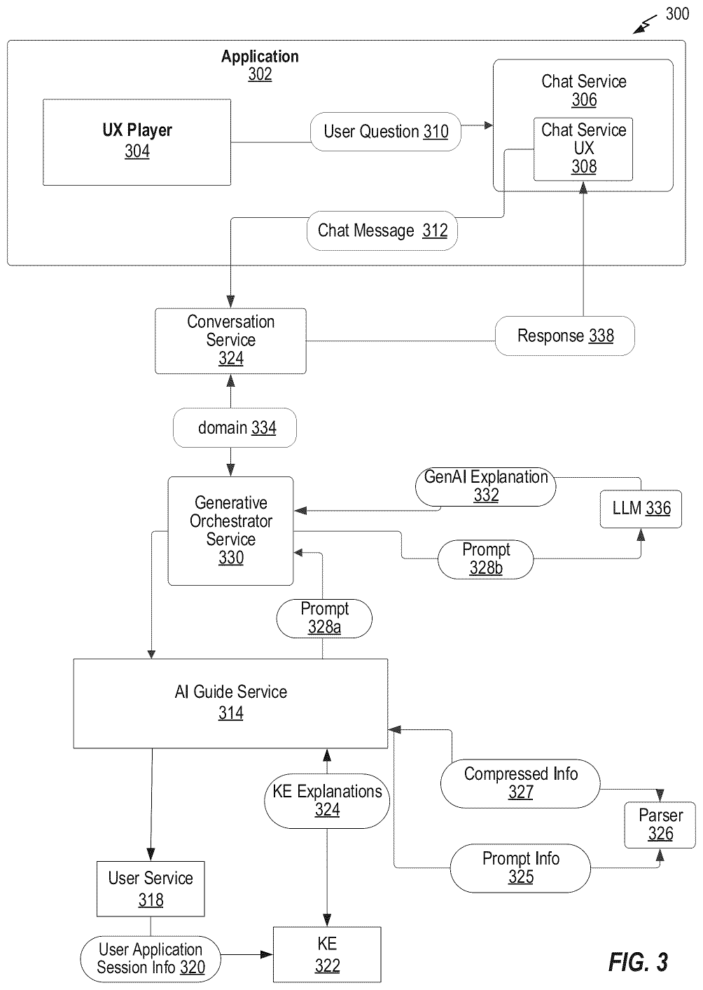

According to aspects described herein in further detail, such as with respect to FIGS. 3, 4, and 5 below, application 104 is configured to interact with GenAI model 110 to generate such response 116 to user question 120. GenAI model 110 utilizes user application session information 112 received from application 104, which may include, for example, user information 106, user question 120, and domain knowledge associated with application 104. GenAI model 110 may beneficially generate a response 116 comprising accurate and user-specific information associated with application output 105 and responsive to user question 120. GenAI model 110 may be prompted with user and application information to generate GenAI response 114 to be provided to user 102 as response 116. User application session information 112 may comprise, information associated with a user and an application session, such as user information 106 inputted to application 104. For an example tax return preparation application, user information may include user income information, tax payment information, demographic information provided to application 104. User application session information 112 may, additionally, and/or alternatively, comprise domain knowledge, determinations, and/or calculations made by application 104, such as to generate application output 105. For an example tax return preparation application, user tax deduction information, user tax credit information, user tax filing status, tax code regulations and guidance, etc. As described herein, response 116 may provide a meaningful explanation of the application output 105 in a manner intended for a non-expert. Thus, user 102 receives an explanation responsive to the user question 120, without using inferior tools and conventional materials, such as a reference to a FAQs section outside of application 104's interface.

GenAI model 110 may be an LLM, for example, a generative pre-trained transformer (GPT) model, trained to process a prompt comprising user application session information 112 and generate GenAI response 114. GenAI model 110 returns the GenAI response 114 to application 104, which may then provide GenAI response 114 as a chat response 116 associated with chat service 108.

Therefore, beneficially, user questions regarding application activities, outcomes, and outputs (e.g., application output 105) receive GenAI responses (e.g., response 116) in a usable manner. Furthermore, such responses may include user and domain-specific explanations and information regarding application outputs.

### Example Workflow for Generating Responsive Generative AI Explanations of Application Outputs

FIG. 2 depicts example user interface 200 depicting a GenAI response 214 to a user question 212 associated with an application output 205. In this example, a user interacts with an income tax return application 204 and receives application output 205 of an estimated tax refund based on the user's income tax return. A GenAI response 214 may be provided as a chat message, depicted here within chat assistant 208 within application 204.

In some embodiments, a user may select a user interface element to launch chat assistant 208 before entering user question 212. In some embodiments, a user may select on a user interface element to request additional explanation, for example, an user interface element “What tax breaks am I receiving?” to launch chat assistant 208 and receive GenAI response 214.

The GenAI response 214 may be responsive to user question 212 inquiring into a facet of application output 205. In particular, the GenAI response 214 comprises a user-specific explanation of a tax credit based on the user's income tax return and other user-specific information, in this example, the user's tax credit and qualifying child. Thus, the user beneficially receives a personalized response to a user question 212 regarding the application output 205 utilizing user application session information (e.g., household information) and domain-specific information (e.g., tax rules) related to application output 205. Further, the explanation is narrowly tailored to the user question 212 and application output 205, for example, by providing relevant domain information, e.g., tax credit information, which was used by application 204 to generate the application output 205. Moreover, GenAI response 214 is provided as a conversational text output to provide a clear and concise response to user question 212. In some embodiments, a user may ask one or more follow up questions via a chat box 216 and received additional explanations responsive to the follow up questions within chat assistant 208.

Note that while not explicitly shown here, application 204 may use a knowledge engine (either an integral part of application 204, or an external component (e.g., accessed through an API, such as in a microservices-type deployment)) to generate application output 205 and information used by the knowledge engine (not depicted) may be provided to the generative AI component as part of the input prompt that results in GenAI response 214.

### Example Workflow for Generating Responsive Generative AI Explanations of Application Outputs

FIG. 3 depicts an example system 300 for generating GenAI responses to user questions regarding application output, for example, of application 104 in FIG. 1, and/or depicted in user interface 200 in FIG. 2. In this example, the GenAI model may be an LLM.

Application 302 may be an example of application 104 FIG. 1. Application 302 comprises a domain-specific application, including, for example, tax calculation and preparation applications, customer support applications, medical diagnosis applications, media and content applications, and others. Application 302 comprises a user experience player 304 configured to display a user interface of application 302, for example user interface 200 in FIG. 2.

A user may interact with a user interface of application 302 to submit a user question 310 (e.g., user question 120 in FIG. 1). In some embodiments, a user may submit user question 310 based on selection of a user interface element, for example, a user interface element requesting additional information. In some embodiments, a user may submit user question 310 through a chat message, such as through a chat service 306. The user question 310 may comprise a request for information and explanation associated an output (e.g., application output 105) of application 302.

Chat service 306 is configured to obtain and provide a response 338 (e.g., response 116 in FIG. 1), to the user question 310, for example, as a chat message displayed in chat service 306. As described herein, the response may comprise a GenAI output of a user-specific explanation and information relating to an application output. Chat service 306 obtains the response 338 from a GenAI model (in this example, LLM 336) based on a prompt of user and domain information. Chat service user experience 308 is a user interface component configured to display response 338 within a user interface of application 302, for example, as depicted in user interface 200 in FIG. 2.

Chat service 306 obtains response 338 from conversation service 316 based on providing chat message 312, including information regarding user question 310, user identifier(s), application identifier(s), and topic identifier(s). Conversation service 316 may comprise an intelligent virtual assistant (IVA) configured to receive, process, and respond to chat messages. Conversation service 316 is configured to determine a domain 334 associated with the chat message 312 to generate a response to the chat message. Conversation service 316 may map an application identifier of chat message 312 to a domain, for example an identifier associated with tax preparation application may be mapped to a tax preparation domain. Based on determining the domain of the chat message 312, conversation service 316 sends the chat message 312 to generative orchestrator service 330 associated with the domain to generate the response.

Generative orchestrator service 330 may comprise an AI planner model configured to determine one or more services and/or models to call to generate the response. An AI planner model is configured to determine a sequence of actions (a “plan”) for accomplishing a requested task using the available services. In this example, generative orchestrator service 330 determines chat message 312 requests an explanatory response based on an output of application 302. Generative orchestrator service 330 may further determine the actions to obtain the response include composing a prompt with user and domain-specific information and providing the prompt to an LLM to obtain the response. Moreover, generative orchestrator service 330 may determine a prompt for an explanatory response may be obtained from AI guide service 314. Generative orchestrator service 330 may also determine the explanatory response may be obtained from an LLM 336 based on the prompt.

AI guide service 314 is configured to obtain a prompt for a responsive explanation of an output of application 302, based on the user question and return the prompt to generative orchestrator service 330.

To generate the prompt, AI guide service 314 is configured to obtain User application session information 320 from user service 318. User service 318 provides user application session information, for example, one or more user attributes, one or more user activities within the application 302, one or more user inputs to the application 302, user location within the application 302, etc. In an example, user application session information for an income tax return application may include user demographic information, income information, household information, tax information, expenditure information, user application activity, and the like.

AI guide service 314 is further configured to obtain a knowledge engine explanation 324 from a knowledge engine 322. Knowledge engine 322 is configured to determine knowledge engine explanations 324 based on the user application session information 320. In an example, knowledge engine 322 may comprise a tax knowledge engine configured to make tax-related determinations based on user inputs within application 302. Knowledge engine 322 may comprise one or more data models and/or rules for a given domain, such as tax calculation for a particular country, state, etc. Based on the user application session information 320, knowledge engine 322 is configured to output one or more knowledge engine explanations 324. Knowledge engine explanations 324 may include, for example, one or more domain rules utilized by application 302 in determining an application output. For example, a tax knowledge engine may process user demographic information, income information, household information, tax information, expenditure information, and the like, according to one or more tax laws, rules, and/or regulations in order to generate tax calculations and determinations. As another example, a medical diagnostic knowledge engine may process user medical information, user symptoms, user demographic information, and the like, in accordance with medical diagnostic models and rules to generate medical diagnostic determinations. Such knowledge engine explanations 324 may not be readily comprehensible by a non-domain expert (e.g., a user 102).

In some embodiments, the knowledge engine explanations 324 may be outputted in an XML, JSON, or other structured data format, which facilitates downstream processing.

User application session information 320 and knowledge engine explanations 324 may be utilized by AI guide service 314 to augment a prompt 328a and thereby to guide the GenAI model (e.g., LLM 336) in generating a more meaningful and user-centric response (e.g., GenAI explanation 332). Beneficially, the GenAI model transforms, complex, domain-specific application outputs (e.g., user application session information 320 and knowledge engine explanations 324) into a clear and responsive explanation. Furthermore, the GenAI model may distill the domain-specific application outputs into a specific and concise response. For example and as described in FIG. 2, the GenAI model may generate a specific response to a user question regarding an application output (e.g., “What tax breaks am I receiving?”). AI guide service 314 is further configured to generate the prompt 328a based on the chat message 312 to generate a response associated with the application output, user application session information 320, and the knowledge engine explanations 324. The prompt 328a may be sent, via generative orchestrator service 330 as prompt 328b, to be used by a GenAI model (e.g., LLM 336) to generate the explanatory response, e.g., GenAI explanation 332.

[symbol] . In certain embodiments, a parser model 326 is configured to process prompt information 325, such as the chat message 312, the user application session information 320 and the knowledge engine explanations 324, to generate compressed prompt information 327 comprising useful information extracted from chat message 312, user application session information 320 and knowledge engine explanations 324. For example, in some examples, the knowledge engine explanations 324 may comprise a number of tokens greater than may be processed by the LLM 336. For example, the knowledge engine explanations 324 may comprise 20,000-50,000 tokens and the LLM 336 may have a limit of 10,000 tokens to process. In certain embodiments, AI guide service 314 may compress the knowledge engine explanations 324 to generate a more compact prompt, e.g., having fewer tokens. In the depicted example, AI guide service 314 utilizes parser model 326 to parse the prompt information 325 to generate the prompt. Parser model 326 is trained to reduce the number of tokens of the prompt information 325324 while maintaining the salient information so that LLM 330 can produce a meaningful explanation. By way of example, parser model 326 may be configured to extract relevant information elements from the prompt information 325 for use in the prompt and sent to AI guide service 314 as compressed information 327.

AI guide service 314 is further configured to identify instructions based on the extracted information elements (e.g., compressed information 327) and add the instructions to the prompt. Such instructions may include instructions to guide the LLM 336 to perform the instructed task and generate the GenAI explanation 332. For example, an instruction may instruct the LLM to generate a human-readable explanation of the knowledge engine explanations 324, for example, text summarization. Another example instruction may instruct the LLM to generate the explanation targeting a non-expert audience. Other example instructions may instruct the LLM to output the explanation in a particular format, provide examples (e.g., few-shot demonstrations of input and output), and others. Instructions may be identified based on information extracted by parser model 326, based on the chat message 312, based on the application output, etc. For example, a text summarization instruction may be identified based on a user question regarding an application output.

As described herein, a technical problem with generative AI models is reducing hallucinations. By providing explicit instructions with an input prompt to the LLM 336, the LLM 336 may generate a meaningful and accurate explanation based on the application output.

AI guide service 314 is configured to provide the prompt 328a to generative orchestrator service 330 for the next action, provide the prompt 328b to the LLM 336. Generative orchestrator service 33—is further configured to call for an LLM response (e.g., GenAI explanation 332) to the prompt from LLM 336.

LLM 336 is configured to generate GenAI explanation 332 based on the prompt. In embodiments, LLM 336 may comprises a GPT model. LLM 336 is trained to process a prompt and generate a generative text output. In particular, LLM 336 may be trained to process a prompt for an explanation of an output in application 302. The response may comprise a human-understandable explanation of the application output, in particular, a domain- and user-specific explanation of an outcome within the application based on the user's question (e.g., user question 310), the user's information, the application information, and the domain-specific knowledge and calculations generated by knowledge engine 322. For example, the GenAI explanation 332 may be an explanation of a user's tax refund amount, e.g., 206 in FIG. 2, an explanation of a user's medical diagnosis, an explanation of a user's media recommendation, and the like.

The GenAI explanation 332 is returned to generative orchestrator service 330 to provide to conversation service 316 for responding to the user question 310. Conversation service 316 returns response 338 to chat service user experience 308 to provide the response in a chat message, such as depicted at 214 in FIG. 2.

System 300 provides many technical benefits by providing aspects for generation of relevant and accurate responses to user questions regarding explanations and information of application output. In certain embodiments, for example, a compact, yet meaningful prompt is generated. The prompt may include domain-specific information, which may further reduce incorrect and/or nonsensical generative output (e.g., reducing generative AI hallucination). Moreover, the prompt may be compressed, such as through the parser model, to a size manageable by the generative AI model. Compact prompts further reduce resource usage and reduce latency of the end-to-end process of providing the explanation to application 302.

Further, the response may be provided as conversational chat to provide improved usability of the explanations and information contained therein. In certain embodiments, for example, the explanatory response may be provided as a chat message, such as via a chat service associated with application 302.

### Example Sequence Flow for Generating Responsive Generative AI Explanations of Application Outputs

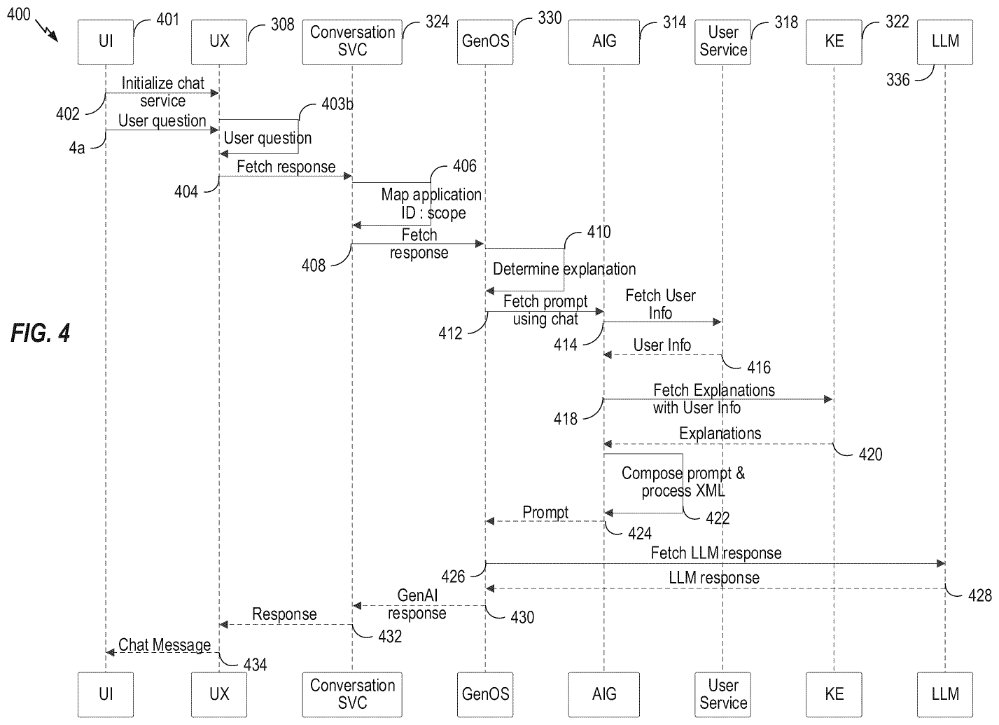

FIG. 4 depicts an example sequence diagram of workflow 400 for generating an AI response to a user question associated with an application output. Workflow 400 is described with respect to various components of system 300 of FIG. 3.

At step 402, a chat user experience of chat service 306 is initialized, such as chat assistant 208 depicted in FIG. 2 as part of user interface 200 of application 204. In some embodiments, a chat user experience may be initialized based on a user selecting a user interface element associated with a user question on a user interface 401 of application 302. In embodiments, a user question (e.g., user question 310) is generated based on the user selection at step 403a. For example, a user interface element may include a request for additional information associated with the application output, e.g., a user interface element displaying “Get further explanation” associated with an application output.

In some embodiments, a chat service user experience 308 may be initialized based on a user launching chat service 306. In embodiments, a user question may be entered (e.g., via a text or voice element) into the chat service user interface at step 403b. For example, as depicted in FIG. 2, a user may select chat assistant 208 and enter, via chat box 216, user question 212. Furthermore, in some embodiments, a user may enter one or more subsequent questions into the chat service user interface.

At step 404, the user question is sent to conversation service (e.g., as part of chat message 312) to request a response to the user question is requested from conversation service 316. The requested response may include a GenAI explanation of an application output within application 302. The response may be provided as a return chat message in chat service user experience 308, such as GenAI response 214 depicted in FIG. 2. Conversation service 316 may receive information associated with the user question, for example, user identifier(s), application identifier(s), and topic identifier(s) as part of chat message 312.

At step 406, conversation service 316 maps an application identifier associated with the application 302 to the domain of the user question. For example, an application identifier of a tax return preparation application may indicate a domain of a tax return.

At step 408, conversation service 316 requests a response to the user question based on mapping the application identifier to a domain from generative orchestrator service 330. At step 410, generative orchestrator service 330 determines to generate a GenAI response to the user question based on the domain of the user question and processing chat message to determine user question requests an explanation of the application output. Further, generative orchestrator service 330 determines a sequence of actions to generate the response to the user question, in this example, by generating a prompt and providing it to LLM 336. At step 412, generative orchestrator service 330 requests the prompt based on the chat message 312 comprising the user question from AI guide service 314.

At step 414, AI guide service 314 request user application session information from user service 318. At step 416, user service 318 returns user application session information (e.g., user application session information 320). User application session information may include user and application information, for example, one or more user attributes, one or more user activities within the application 302, one or more user inputs to the application 302, user location within the application 302, etc.

At step 418, AI guide service 314 requests a knowledge engine explanation (e.g., knowledge engine explanation 324) based on the user application session information from knowledge engine 322. At step 420, knowledge engine 322 returns the knowledge engine explanation. A knowledge engine explanation may comprise labeled, categorized, and structured data including data explaining one or more determinations made by the knowledge engine in generating the application output. Examples include a domain-specific knowledge engine for a tax domain comprising tax knowledge, rules, and models, a domain-specific knowledge engine for a medical diagnosis domain comprising medical diagnostic knowledge, rules, and models, and others. For example, a knowledge engine explanation for a tax domain may comprise one or more tax calculations (e.g., income, taxable income, tax paid, tax credit, etc.) and associated explanations (e.g., child tax credit applied based on qualifying child). Such knowledge engine explanations may not be reader friendly, for example, targeted to a domain-expert, such as including domain-expert terminology, knowledge, and readability. The knowledge engine explanation may be in a non-human comprehensive format, for example, an XML format.

At step 422, AI guide service 314 composes a prompt (e.g., prompt 328a), based on the knowledge engine explanation, for LLM 336. For a tax preparation application, an example prompt may comprise income, taxable income, tax paid, tax credit, etc. and associated explanations. In some embodiments, composing the prompt comprises identifying one or more instructions and adding the one or more instructions to the knowledge engine explanations. For example, an instruction to generate a GenAI response may include an instruction to complete the task of text summarization of the prompt. As another example, an instruction may include one or more example inputs and outputs. For example, a prompt may comprise an instruction to complete the task of a text summary of provided knowledge engine data (e.g., knowledge engine explanation 324), targeted towards Tom, a non-expert end user (e.g., user 102). The prompt may further comprise one or more demonstrative examples of input data and a text summary output. By providing explicit instructions with an input prompt to the LLM 336, the LLM 336 may generate a meaningful and accurate explanation based on the application output.

In some embodiments, composing the prompt comprises compressing the knowledge engine explanations.

In some embodiments, composing the prompt comprises parsing the knowledge engine explanations with a parsing model to reduce the number of tokens of the prompt. For example in a tax preparation application, the knowledge engine explanations may comprise:

```
<TaxReturn>
  <Input>
    < Key>Income</Key>
    <Value>76548</Value>
  </Input>
  <Input>
    <Key>TaxesPaid</Key>
    <Value>4634</Value>
  </Input>
</TaxReturn>.
```

A compressed prompt may comprise:
Income: 76548, TaxesPaid: 4634.

As described herein, a prompt with many tokens may be too large to be processed by the generative AI model, for example, too large for the memory of the model, and/or require extensive resources and time to process the prompt and generate an explanation. By compressing or parsing the prompt, resource usage and latency may be reduced and the generative AI model may process the prompt.

At step 424, AI guide service 314 provides the prompt (e.g., prompt 328a) to generative orchestrator service 330 to generate the GenAI response with associated LLM 336.

At step 426, generative orchestrator service 330 requests an LLM response from LLM 336 based on the prompt. In particular, generative orchestrator service 330 provides the prompt to LLM 336, which processes the prompt and generates a generative text output (e.g., GenAI explanation 332), for example, a domain- and user-specific explanatory text of an application output.

At step 428, LLM 336 provides the GenAI response to generative orchestrator service 330 based on processing the prompt. In embodiments, LLM 336 processes the prompt to generate a human-understandable explanation responsive to the user question. For example, the GenAI explanation may be a response explaining a user's tax credits, e.g., 214 in FIG. 2, an explanation of a user's medical diagnosis, an explanation of a user's media recommendation, and the like.

At step 430, generative orchestrator service 330 provides the GenAI explanation to conversation service 316 to reply to the user question. At step 432, conversation service 316 provides the response to the chat service user experience 308 to render for sending, at step 434, as a chat message, such as depicted in FIG. 2. Beneficially, the response generated by the generative model may be presented as a reply to a user question, such as via a chat service, within an application's user interface, e.g., user interface 200 in FIG. 2, improving usability for the user and avoiding the conventional requirement for a user to navigate to different portions of the application (e.g., a help section) for generic explanations associated with application output. Moreover, the response may be provided as part of a conversation, such that a user may ask additional questions.

Furthermore, workflow 400 provides many technical benefits by providing aspects for generation of relevant and accurate GenAI explanatory responses. In certain embodiments, for example, a compact, yet meaningful prompt is generated. The prompt may include domain-specific information, which may further reduce incorrect and/or nonsensical generative output (e.g., reducing generative AI hallucination). Moreover, the prompt may be compressed, such as through the parser model, to a size manageable by the generative AI model. Compact prompts further reduce resource usage and reduce latency of the end-to-end process of providing the response to the user via application 302. Thus, users may beneficially receive meaningful explanations responsive to user questions regarding application outputs.

Note that FIG. 4 is just one example of a workflow, and other workflows including fewer, additional, or alternative steps are possible consistent with this disclosure.

### Example Method for Generating a Responsive Generative AI Explanation

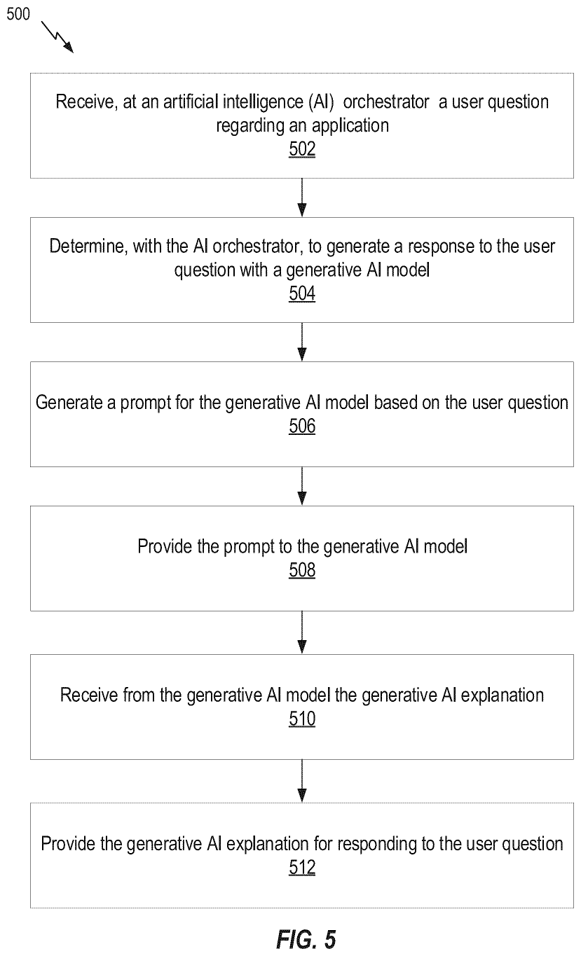

FIG. 5 depicts an example method 500 for generating a responsive generative AI explanation of an application outcome, such as application 104 in FIG. 1 or application 302 in FIGS. 3 and 4.

Initially, at step 502, method 500 begins with receiving, at an artificial intelligence (AI) orchestrator a user question regarding an application. The AI orchestrator is an example of generative orchestrator service 330 in FIG. 3. In some embodiments, the user question is received via selection of a user interface element associated with the application. In some embodiments, the user question is received via a chat service.

At step 504, method 500 proceeds with determining, with the AI orchestrator, to generate a generative AI response to the user question with a generative AI model, such as described with respect to step 410 in FIG. 4. In some embodiments, determining, with the AI orchestrator, to generate the generative AI response to the user question with the generative AI model comprises: determining a domain associated with the user question; and determining user question comprises a request for an explanation of an output of the application.

[symbol]

At step 506, method 500 proceeds with generating a prompt for the generative AI model based on the user question, for example, as described with respect to step 420 in FIG. 4. In some embodiments, generating the prompt for the GenAI model based on the user question comprises receiving user application session information associated with the user and the application output; providing the user application session information to a knowledge engine; receiving from the domain-specific knowledge engine a knowledge engine explanation; generating the prompt based on the knowledge engine explanation. In some embodiments, the knowledge engine explanation is in XML format, and generating the prompt based on the knowledge engine explanation comprises parsing the knowledge engine explanation for information elements used in the prompt for the generative AI model. In some embodiments, the information elements are parsed by processing the knowledge engine explanation with a parser model trained to reduce a number of tokens of the prompt for the generative AI model.

In some embodiments, generating the prompt further comprises compressing the prompt.

At step 508, method 500 proceeds with providing the prompt to the generative AI model. The GenAI model processes the prompt and generates the GenAI explanation. In some embodiments, the GenAI model is a large language machine learning model, for example LLM 336.

At step 510, method 500 proceeds with receiving from the generative AI model the generative AI response, for example, as described with respect to at step 428 in FIG. 4. The GenAI response may comprise a human-understandable text explanation of an application output responsive to the user question.

At step 512, method 500 proceeds with providing the generative AI response for responding to the user question, for example, as described with respect to step 432 in FIG. 4. In some embodiments, the generative AI response comprises a chat message for sending via a chat service, for example, as GenAI response 214 in FIG. 2.

Method 500 provides many technical benefits by providing aspects for generation of relevant and accurate GenAI explanatory responses to user questions. For example, in certain embodiments, a GenAI orchestrator determines, based on the user question, a sequence of actions to generate a GenAI explanatory response and automatically executes the actions to generate the response. In certain embodiments, for example, a compact, yet meaningful prompt is generated. The prompt may include domain-specific information, which may further reduce incorrect and/or nonsensical generative output (e.g., reducing generative AI hallucination). Moreover, the prompt may be compressed, such as through the parser model, to a size manageable by the generative AI model. Compact prompts further reduce resource usage and reduce latency of the end-to-end process of providing the response to the user via an application. Thus, users may beneficially receive meaningful explanations responsive to user questions regarding application outputs.

Note that FIG. 5 is just one example of a method, and other methods including fewer, additional, or alternative steps are possible consistent with this disclosure.

### Example Processing System for Generating a Responsive Generative AI Explanation

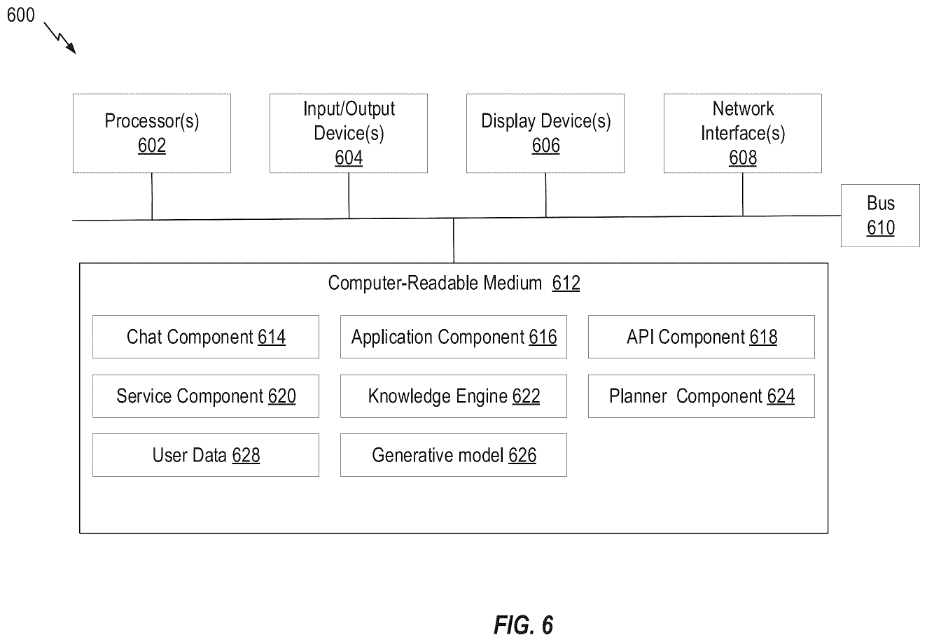

FIG. 6 depicts an example processing system 600 configured to perform various aspects described herein, including, for example, workflow 400 as described above with respect to FIG. 4, or method 500 as described above with respect to FIG. 5. Example applications include application 104 in FIG. 1, application 204 in FIG. 2, or application 302 in FIG. 3.

Processing system 600 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 600 includes one or more processors 602, one or more input/output devices 604, one or more display devices 606, one or more network interfaces 608 through which processing system 600 is connected to one or more networks (e.g., a local network, an intranet, the Internet, or any other group of processing systems communicatively connected to each other), and computer-readable medium 612. In the depicted example, the aforementioned components are coupled by a bus 610, which may generally be configured for data exchange amongst the components. Bus 610 may be representative of multiple buses, while only one is depicted for simplicity.

Processor(s) 602 are generally configured to retrieve and execute instructions stored in one or more memories, including local memories like computer-readable medium 612, as well as remote memories and data stores. Similarly, processor(s) 602 are configured to store application data residing in local memories like the computer-readable medium 612, as well as remote memories and data stores. More generally, bus 610 is configured to transmit programming instructions and application data among the processor(s) 602, display device(s) 606, network interface(s) 608, and/or computer-readable medium 612. In certain embodiments, processor(s) 602 are representative of a one or more central processing units (CPUs), graphics processing unit (GPUs), tensor processing unit (TPUs), accelerators, and other processing devices.

Input/output device(s) 604 may include any device, mechanism, system, interactive display, and/or various other hardware and software components for communicating information between processing system 600 and a user of processing system 600. For example, input/output device(s) 604 may include input hardware, such as a keyboard, touch screen, button, microphone, speaker, and/or other device for receiving inputs from the user and sending outputs to the user.

Display device(s) 606 may generally include any sort of device configured to display data, information, graphics, user interface elements, and the like to a user. For example, display device(s) 606 may include internal and external displays such as an internal display of a tablet computer or an external display for a server computer or a projector. Display device(s) 606 may further include displays for devices, such as augmented, virtual, and/or extended reality devices. In various embodiments, display device(s) 606 may be configured to display a graphical user interface.

Network interface(s) 608 provide processing system 600 with access to external networks and thereby to external processing systems. Network interface(s) 608 can generally be any hardware and/or software capable of transmitting and/or receiving data via a wired or wireless network connection. Accordingly, network interface(s) 608 can include a communication transceiver for sending and/or receiving any wired and/or wireless communication.

Computer-readable medium 612 may be a volatile memory, such as a random access memory (RAM), or a nonvolatile memory, such as nonvolatile random access memory (NVRAM), or the like. In this example, computer-readable medium 612 includes chat component 614, API component 618, service component 620, knowledge engine 622, user data 628, generative model 626, and orchestrator component 624.

In certain embodiments, chat component 614 configured to send and receive chat messages, for example, user questions and responses.

In certain embodiments, application component 616 is configured to interface with a user, for example, through a user interface, to facilitate one or more services and provide associated explanations. Application component 616 may be an example of application 104 in FIG. 1.

In certain embodiments, API component 618 is configured to provide one or more APIs to facilitate communication between one or more components, for example, facilitate sending and/or receiving requests and data.

In certain embodiments, service component 620 is configured to generate a GenAI explanation associated with application component 616, including, for example, generating a prompt for a GenAI explanation with generative model 626 and obtaining user data 628.

In certain embodiments, knowledge engine 622 is configured to provide knowledge calculations and explanations associated with application component 616, for example, as described with respect to knowledge engine 322 in FIGS. 3 and 4.

In certain embodiments, orchestrator component 624 is configured to select a generative model 626 for generating an explanation and obtain the explanation based on providing generative model 626 with the prompt.

Note that FIG. 6 is just one example of a processing system consistent with aspects described herein, and other processing systems having additional, alternative, or fewer components are possible consistent with this disclosure.

### Example Clauses

Implementation examples are described in the following numbered clauses:
Clause 1: A computer-implemented method, comprising: receiving, at an artificial intelligence (AI) orchestrator a user question regarding an application used by a user; determining, with the AI orchestrator, to generate a generative AI response to the user question with a generative AI model; generating a prompt for the generative AI model based on the user question, comprising: receiving user application session information associated with the user and the application output; providing the user application session information to a knowledge engine; receiving from the knowledge engine a knowledge engine explanation; generating the prompt based on the knowledge engine explanation; providing the prompt to the generative AI model; receiving from the generative AI model the generative AI response; and providing the generative AI response for responding to the user question.
Clause 2: The computer-implemented method of clause 1, wherein the user question is received via selection of a user interface element associated with the application.
Clause 3: The computer-implemented method of clause 1, wherein the user question is received via a chat service.
Clause 4: The computer-implemented method of any one of clauses 1-4, wherein: the knowledge engine explanation is in XML format, and generating the prompt based on the knowledge engine explanation comprises parsing the knowledge engine explanation for information elements used in the prompt for the generative AI model.
Clause 5: The computer-implemented method of clause 4, wherein the information elements are parsed by processing the knowledge engine explanation with a parser model trained to reduce a number of tokens of the prompt for the generative AI model.
Clause 6: The computer-implemented method of any one of clauses 1-5, wherein the generating the prompt further comprises compressing the prompt.
Clause 7: The computer-implemented method of any one of clauses 1-6, wherein the generative AI model is a large language machine learning model.
Clause 8: The computer-implemented method of any one of clauses 1-7, wherein the generative AI response comprises a chat message for sending via a chat service.
Clause 9: The computer-implemented method of any one of clauses 1-8, wherein determining, with the AI orchestrator, to generate the generative AI response to the user question with the generative AI model comprises: determining a domain associated with the user question; and determining user question comprises a request for an explanation of an output of the application.
Clause 10: A processing system, comprising: a memory comprising computer-executable instructions; and a processor configured to execute the computer-executable instructions and cause the processing system to perform a method in accordance with any one of Clauses 1-9.
Clause 11: A processing system, comprising means for performing a method in accordance with any one of Clauses 1-9.
Clause 12: A non-transitory computer-readable medium storing program code for causing a processing system to perform the steps of any one of Clauses 1-9.
Clause 13: A computer program product embodied on a computer-readable storage medium comprising code for performing a method in accordance with any one of Clauses 1-9.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
receiving, at an artificial intelligence (AI) orchestrator a user question regarding an application used by a user;
determining, with the AI orchestrator, to generate a generative AI response to the user question with a generative AI model;
generating a prompt for the generative AI model based on the user question, comprising:
receiving user application session information associated with the user and the application;
providing the user application session information to a knowledge engine;
receiving from the knowledge engine a knowledge engine explanation; and
generating the prompt based on the knowledge engine explanation;
providing the prompt to the generative AI model;
receiving from the generative AI model the generative AI response; and
providing the generative AI response for responding to the user question.

2. The computer-implemented method of claim 1, wherein the user question is received via selection of a user interface element associated with the application.

3. The computer-implemented method of claim 1, wherein the user question is received via a chat service.

4. The computer-implemented method of claim 1, wherein:
the knowledge engine explanation is in XML format, and
generating the prompt based on the knowledge engine explanation comprises parsing the knowledge engine explanation for information elements used in the prompt for the generative AI model.

5. The computer-implemented method of claim 4, wherein the information elements are parsed by processing the knowledge engine explanation with a parser model trained to reduce a number of tokens of the prompt for the generative AI model.

6. The computer-implemented method of claim 1, wherein the generative AI response comprises a chat message for sending via a chat service.

7. The computer-implemented method of claim 1, wherein the generative AI model is a large language machine learning model.

8. The computer-implemented method of claim 1, wherein the generating the prompt further comprises compressing the prompt.

9. The computer-implemented method of claim 1, wherein determining, with the AI orchestrator, to generate the generative AI response to the user question with a generative AI model comprises:
determining a domain associated with the user question; and
determining the user question comprises a request for an explanation of an output of the application.

10. A processing system, comprising: a memory comprising computer-executable instructions; and a processor configured to execute the computer-executable instructions and cause the processing system to:
receive, at an artificial intelligence (AI) orchestrator, a user question regarding an application used by a user;
determine, with the AI orchestrator, to generate a generative AI response to the user question with a generative AI model;
generate a prompt for the generative AI model based on the user question, comprising:
receive user application session information associated with the user and the application;
provide the user application session information to a knowledge engine;
receive from the knowledge engine a knowledge engine explanation; and
generate the prompt based on the knowledge engine explanation;
provide the prompt to the generative AI model;
receive from the generative AI model the generative AI response; and
provide the generative AI response for responding to the user question.

11. The processing system of claim 10, wherein the user question is received via selection of a user interface element associated with the application.

12. The processing system of claim 10, wherein the user question is received via a chat service.

13. The processing system of claim 10, wherein:
the knowledge engine explanation is in XML format, and
the processor is configured to cause the processing system to generate the prompt based on the knowledge engine explanation comprising parsing the knowledge engine explanation for information elements used in the prompt for the generative AI model.

14. The processing system of claim 13, wherein the information elements are parsed by processing the knowledge engine explanation with a parser model trained to reduce a number of tokens of the prompt for the generative AI model.

15. The processing system of claim 10, wherein the generative AI response comprises a chat message for sending via a chat service.

16. The processing system of claim 10, wherein the generative AI model is a large language machine learning model.

17. The processing system of claim 10, wherein to generate the prompt, the processing system is further configured to compress the prompt.

18. The processing system of claim 10, wherein to determine, with the AI orchestrator, to generate the generative AI response to the user question with a generative AI model, the processing system is further configured to:
determine a domain associated with the user question; and
determine the user question comprises a request for an explanation of an output of the application.

19. A computer-implemented method, comprising:
receiving, at an artificial intelligence (AI) orchestrator a user question regarding an application used by a user;
determining, with the AI orchestrator, to generate a generative AI response to the user question with a generative AI model, comprising:
determining a domain associated with the user question; and
determining the user question comprises a request for an explanation of an output of the application;
generating a prompt for the generative AI model based on the user question, comprising:
receiving user application session information associated with the user and the application;
providing the user application session information to a knowledge engine;
receiving from the knowledge engine a knowledge engine explanation, wherein the knowledge engine explanation is in XML format; and
generating the prompt based on the knowledge engine explanation, comprising parsing the knowledge engine explanation for information elements used in the prompt for the generative AI model;
providing the prompt to the generative AI model;
receiving from the generative AI model the generative AI response; and
providing the generative AI response for responding to the user question, wherein the generative AI response comprises a chat message for sending via a chat service.

20. The computer-implemented method of claim 19, wherein the information elements are parsed by processing the knowledge engine explanation with a parser model trained to reduce a number of tokens of the prompt for the generative AI model.
